(19) United States
(12) Patent Application Publication
(10) Pub. No.: US 2007/0009159 A1
(43) Pub. Date: Jan. 11, 2007

(54) Image recognition system and method using holistic Harr-like feature matching

(75) Inventor: Lixin Fan, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/452,761

(22) Filed: Jun. 14, 2006

Related U.S. Application Data
(60) Provisional application No. 60/694,016, filed on Jun. 24, 2005.

(51) Int. Cl. G06K 9/62

(52) U.S. Cl. 382/209

(57) ABSTRACT

A method and system for holistic Harr-like feature matching for image recognition includes extracting features from a test image where the extracted features are Harr-like features extracted from key points in the test image, matching extracted features from the test image with features from a template image, transforming the test image according to matched extracted features, and providing match results

### CROSS REFERENCE TO RELATED APPLICATIONS

The present application claims priority to U.S. Provisional Application No. 60/694,016, filed Jun. 24, 2005 and incorporated herein by reference in its entirety.

### BACKGROUND OF THE INVENTION

1. Field of the Invention

The present invention relates generally to image recognition systems and methods. More specifically, the present invention relates to image recognition systems and methods including holistic Harr-like feature matching.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Matching a template image to a target image is a fundamental computer vision problem. Numerous matching methods (from naïve template matching to more sophisticated graph matching) have been developed over last two decades. Nevertheless, people are continuously looking for robust matching methods that can deal with different imaging conditions such as illumination differences and intra-class variation, scaling and varying view angles, occlusion and cluttered background.

Image recognition is key to many mobile applications like vision-based interaction, user authentication, augmented reality and robots. However, traditional image recognition techniques require laborious training efforts and expert knowledge in pattern recognition and learning. The training process often involves manual selecting and pre-processing (i.e. cropping and aligning) of many (hundreds to thousands) example images, which are subsequently processed by certain learning methods. Depending on the nature of the learning methods, the learning may require parameter adjusting and long training time. Due to this bottleneck in the training process, existing image recognition systems are restricted to limited number of pre-selected objects. End users have neither freedom nor expertise to create new recognition systems on their own.

Numerous matching methods have been developed for image recognition to match images under different conditions. For example, the template matching method is accurate but takes a lot of computations to deal with small deviations from the template (e.g., shifted 2 or 3 pixels or rotated gently). Occlusion, deformation or intra-class variations are even more problematic for naïve template matching. Another method is example-based recognition requiring manual preparation (e.g., selecting, cropping and aligning) of training images. This method can deal with intra-class variations, but not deformation and occlusion.

Other example matching methods include deformable template (or active contour, active shape models) methods, which exhibit flexibility in shape variation, by matching some pre-defined pivot landmark points. Examples of deformable template methods can be found in (1) Y. Amit, U. Grenander, and M. Piccioni, “Structural image restoration through deformable template,” J. Am. Statistical Assn., vol. 86, no. 414, pp. 376-387, June 1991; (2) A. L. Yuille, P. W. Hallinan, and D. S. Cohen, “Feature extraction from faces using deformable templates,” Int'l J. Computer Vision, vol. 8, no. 2, 133-144, 1992; (3) F. Leymarie and M. D. Levin, “Tracing deformable objects in the plane using an active contour model,” IEEE Trans. Pattern Analysis and Machine Intelligence, vol. 15, pp. 617-635, 1993; (4) U.S. Pat. No. 6,574,353 entitled “Video object tracking using a hierarchy of deformable templates;” and (5) T. F. Cootes, C. J. Taylor, Active Shape Models—“Smart Snakes” in Proc. British Machine Vision Conference. Springer-Verlag, 1992, pp. 266-275. There are drawbacks in the deformable template approach. One drawback is that manual construction of landmark points is laborious and requires expertise. As such, it is extremely difficult (if not impossible) for a layperson to create new template models. Another drawback is that the matching is sensitive to clutter and occlusion because edge information is used.

Yet another matching method is called elastic graph matching, which is similar in nature to deformable template methods, but the matching process is augmented with wavelet jet comparison. An example of elastic graph matching is found in U.S. Pat. No. 6,222,939 entitled “Labeled Bunch Graphs for Image Analysis.” Elastic graph matching requires manual construction of some landmark points (represented by graph nodes). Further, elastic graph matching is less sensitive to clutter and occlusion is still problematic.

Another matching method is local feature-based matching, which uses a Harris corner detector to detect repeatable and distinctive feature points, and rotation invariant features to describe local image contents. Nevertheless, local feature-based matching lacks a holistic matching mechanism. As a result, these methods cannot cope with intra-class variations. Examples of local feature-based matching can be found in C. Schmid and R. Mohr, “Local Grayvalue Invariant for Image Retrieval,” PAMI 1997, and D. Lowe, “Object Recognition from Local Scale-Invariant Features,” ICCV 1999.

Another matching method is color tracking methods, which use color histograms to track color regions. These methods are restricted to color input video and break down when there are significant illumination (and color) changes or intra-class variations.

Existing image recognition systems are bulky, expensive, limited to special-purpose processing (e.g., color tracking), and often require extensive training efforts. Such systems are limited in their recognition processing to some pre-trained object classes (e.g., face recognition). An example of an existing image recognition system is the CMUcam2 (available at http://www-2.cs.cmu.edu/-cmucam/cmucam2/ and http://www.roboticsconnection.com/catalog/item/1764263/1194844.htm), which can track user-defined color blobs at up to 50 frame per second (fps). Another example is the Evolution Robotics ERI robot system (available at http://www.evolution.com/er1/ and http://www.evolution.com/core/vipr.masn), which can track color objects only given a certain object pattern. These systems, however, are limited to special purposes.

Thus, there is a need for a image recognition model requiring limited, if any, training and expert knowledge. Further, there is a need for a holistic matching method to match objects under different imaging conditions. Yet further, there is a need for a real-time, general purpose, and low cost vision system for mobile applications.

### SUMMARY OF THE INVENTION

In general, the present invention provides an image recognition method and system, which require little, if any, training efforts and expert knowledge. With this recognition system and method, supporting technology and user interface, an end-user can build his or her own recognition systems. For instance, a user may take a picture of his or her dog with a camera phone and the dog will be recognized by the camera later. A system implementing the present invention can achieve general purpose recognition at speeds up to about 25 fps, in comparison to the 18 fps that is possible with many conventional systems.

One exemplary embodiment relates to a method of image matching a test image to a template image. The method includes extracting features from a test image where the extracted features are Harr-like features extracted from key points in the test image, matching extracted features from the test image with features from a template image, transforming the test image according to matched extracted features, and providing match results.

Another exemplary embodiment relates to a device having programmed instructions for image recognition between a test image and stored template images. The device includes an interface configured to receive a test image, an extractor configured to extract features from the test image, and instructions that perform a matching operation where extracted features from the test image are matched with features from a template image to generate match results. The extracted features are Harr-like features extracted from key points in the test image.

Another exemplary embodiment relates to a system for image recognition. The system includes a pre-processing component that performs image normalization on a test image, a feature extraction component that extracts Harr-like features from the test image, a matching component that matches features extracted from the test image with features from a template image, and an image transformation component that performs transformation operations on the test image. The Harr-like features are from key points in the test image.

Other exemplary embodiments are also contemplated, as described herein and set out more precisely in the appended claims.

### BRIEF DESCRIPTION OF DRAWINGS

FIG. 1 is a diagram of operations performed in a holistic Harr-like feature matching process in accordance with an exemplary embodiment.

FIG. 2 is a diagrammatical representation of sample point alignment in accordance with an exemplary embodiment.

FIG. 3 is a diagrammatical representation of Harr feature block alignment in accordance with an exemplary embodiment.

FIGS. 4a and 4b are diagrammatical representations of an exemplary invariant feature and the effect of an adaptation mechanism.

FIG. 5 is a diagrammatical representation of a holistic feature point match in accordance with an exemplary embodiment.

FIG. 6 is user interfaces illustrating example face detection and tracking results under intra-class variation in accordance with an exemplary embodiment.

FIG. 7 is user interfaces illustrating example face detection and tracking results in accordance with an exemplary embodiment.

FIG. 8 is user interfaces illustrating example object detection and tracking results in accordance with an exemplary embodiment.

FIG. 9 is a block diagram representation of a recognition system having a pipeline design and interaction with an application client in accordance with an exemplary embodiment.

### DETAILED DESCRIPTION OF EXEMPLARY EMBODIMENTS

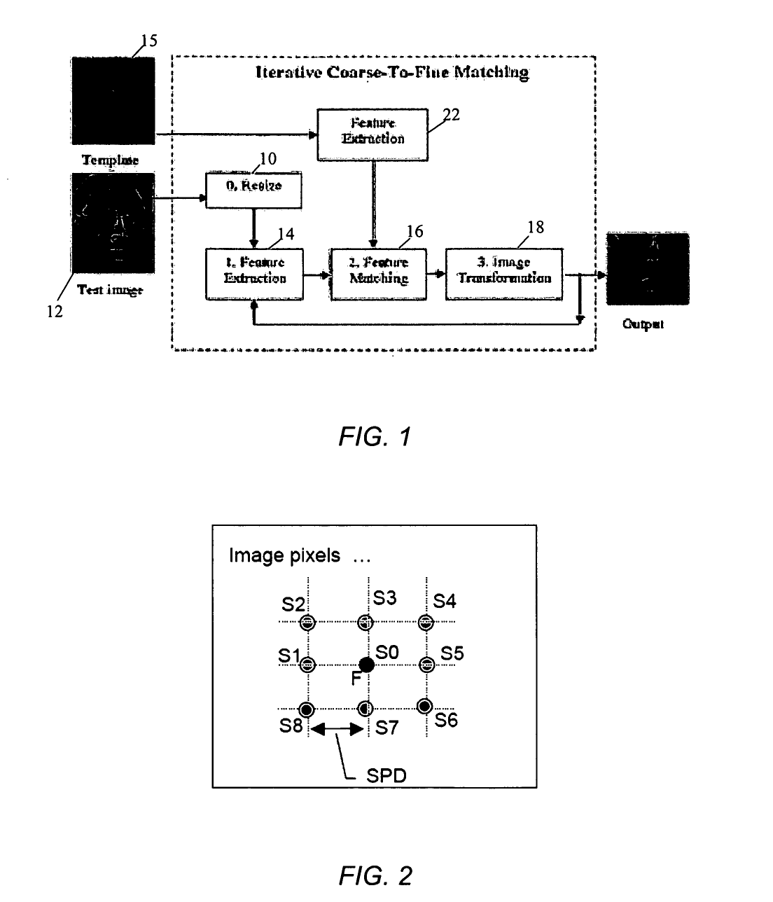

FIG. 1 illustrates operations performed in a holistic Harr-like feature matching process in accordance with an exemplary embodiment. Additional, fewer, or different operations may be performed depending on the embodiment or implementation. In an operation 10, a test image 12 is resized. An operation 14 involves feature extraction in which invariant Harr-like features are extracted from key points, such as corners and edges. For images which are 100 by 100 pixels, 150 to 300 feature points can be extracted.

Feature extraction includes feature point detection and description. Not all image pixels are good features to match, and thus only a small set of feature points (e.g., between 100 and 300 for 100 by 100 images) are automatically detected and used for matching. Preferably, feature points are repeatable, distinctive and invariant.

Generally, high gradient edge points are in repeatable features, since they can be reliably detected under illumination changes. Nevertheless, edge points alone are not very distinctive in their localizations, since one edge point may match well to many points of a long edge. Corners and junctions, on the other hand, are much more distinctive concerning localization. According to an exemplary embodiment, a Harris corner detector is used to select features.

Describing local image content around each feature point is important to successful image matching. A set of Harr-like descriptors are used to characterize local image content. FIG. 2 illustrates an exemplary sample point alignment. For each feature point (F), Harr-like features are extracted at 9 sample points, illustrated in FIG. 2 by S0, S1, S2, . . . S8. The center sample point (S0) coincides with the feature point F, while eight neighboring sample points (S1 to S8) are off-center along eight different orientations. The sample point distance (SPD) is equal to the size of block squares in which Harr feature are extracted.

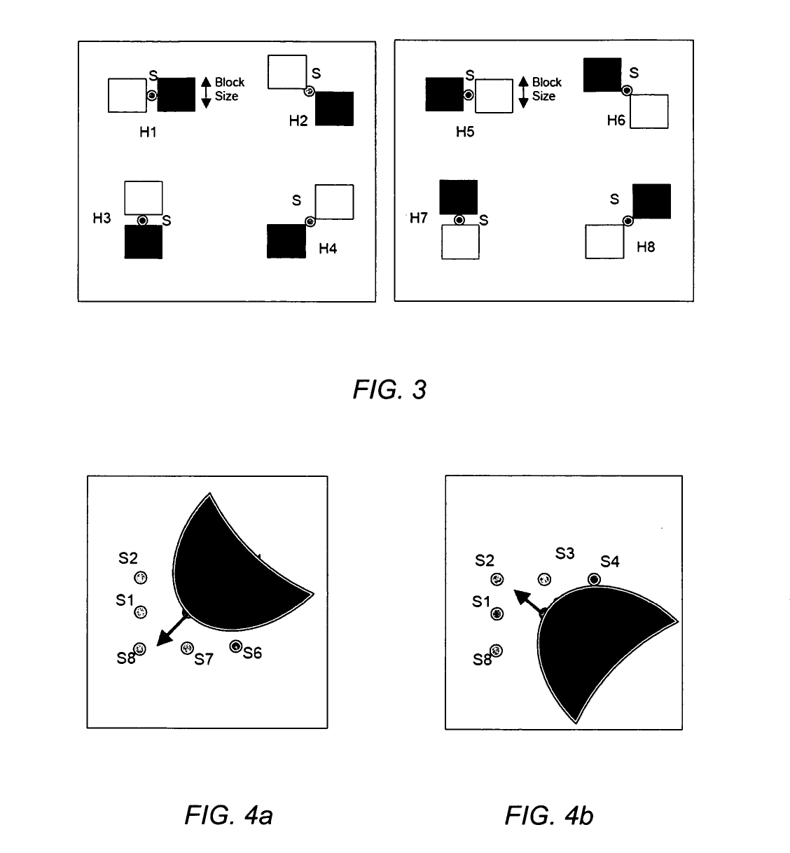

FIG. 3 illustrates exemplary Harr feature block alignments. For each sample point (Si), eight Harr-like features (H1 to H8) can be extracted with respect to Si. These eight Harr-like features correspond to Average Block Intensity Differences (ABID) along eight orientations where Hi=Average_Intensity_WHITE_block—Average_Intensity_BLACK_block; where the Block Square Size is an important parameter. Note that H5=negative(H1), H6=negative(H2), H7=negative(H3) and H8=negative(H4), due to the symmetry block alignment. As such, there are only four independent quantities, resulting in a four-dimensional Harr-like feature extracted at each sample points. As described below, though, H5 to H8 is not discarded while H1 to H4 is kept. Each feature point F leads to a 36-dimensional (=9 Sample points*4 orientations) Harr-like feature. The order of these 36 components is not fixed, but instead determined adaptively according to dominant local edge orientation.

When images undergo rotation and scaling, so does the local image content and feature extracted thereby. As such, it is possible to have false matches. The rotation and scaling of the local image content and extracted features are taken into account when extracting features invariant to geometrical transformations. To deal with scaling, multi-scale features are extracted with multiple block square sizes (ranging from 3 to 17) and the holistic matching process is left to select the best match.

To deal with rotation, Harr-like feature extraction is adapted according to dominant local edge orientations. An exemplary implementation can be as follows. At the center sample point S0, H1 to H8 are extracted. The component with maximum values is found and the corresponding orientation (i.e. the dominant edge orientation) is indexed as i_max. First, [H_(i_max), then H_(i_max+1), H_(i_max+2) and H_(i_max+3)] are selected. The other 4 components are discarded due to symmetry. If i_max+1==9, i_max is set back to 1, and so on. Next, starting from sample point S_(i_max), H1 to H8 are extracted and [H_(i_max) H_(i_max+1) H_(i_max+2) H_(i_max+3)] are kept. The process is repeated for S_(i_max+1) to S_(i_max+7). If i_max+1=9, i_max is set back to 1.

FIGS. 4a and 4billustrate an exemplary invariant feature and the effect of the adaptation mechanism. The arrow indicates the dominant local edge orientation. When the feature point F lies on the curved edge of a dark region (FIG. 4a), H8 is the maximum value and thus the next sample point is S8, then S1, S2 . . . so on. When the same image undergoes rotation (e.g., 90 degrees, FIG. 4b), H2 becomes the maximum and S2, S3, . . . are extracted. Thus, the invariance is retained.

Harr-like features are used instead of Gabor or wavelet features because that Harr-features can be computed rapidly using a technique called Integral Image described in Paul Viola and Michael Jones, Robust Real-time Object Detection. Also, Harr features have been proved to be discriminative features for the purpose of real-time object detection.

Finally, for each feature point F, we also record their X,Y coordinates within image space. Thus, each feature point gives rise to a 36-dimensional Harr quantities and 2-dimensional spatial coordinates. The spatial coordinate is an important ingredient of successful holistic feature matching, as discussed in greater detail below.

Referring again to FIG. 1, after the feature extraction of operation 14, an operation 16 involving feature matching is performed in which two sets of feature points are compared (one set from a template image 15 and another set from the test image 12) and similar coherent point pairs are selected. For example, for 100 by 100 pixel images, 20 to 100 point pairs can be selected. The term “similar” indicates that these features are not only alike in terms of their Harr quantities (Hi), but also exhibit consistent spatial configurations. A feature extraction operation 22, similar to operation 14, is used on template image 15 to obtain feature points from the template image 15.

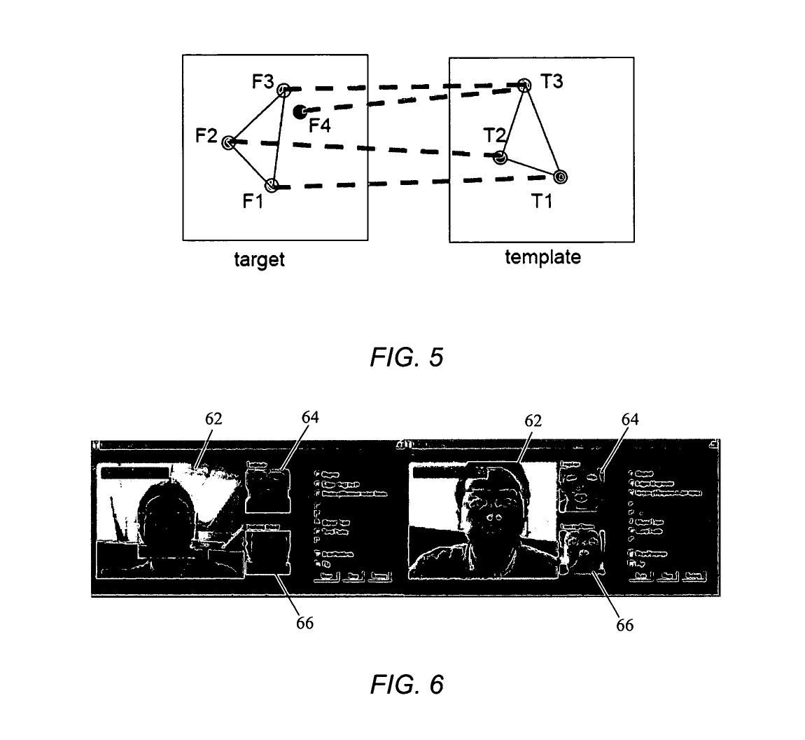

For example in FIG. 5, if F1 and F2 are good match of T1 and T2, then F3 is favored to F4 since triangle F123 is similar to its counterpart T123 (subject to scaling and rotation). Therefore, the similarity between two feature points is determined by the differences between Harr quantities and the displacement between spatial coordinates.

To find good match points, an exponential function is used to penalize the compound difference in both aspects. This exponential funcation of good match points, g, can be represented as:

$$g = exp ( - \frac{d}{σ} - \frac{f}{γ} )$$

where f and d denote Mean Squared Harr and spatial differences respectively. Sigma and gamma are two weight parameters. The above function reaches a maximum of 1 for two identical features and decreases otherwise. For each template feature point, the best match is the target feature point that has the maximum g value. Working together with the iterative image transformation, this compound g function imposes structural constraint on matched points.

Due to the presence of cluttered background, occlusion and intra-class variation, extracted features are inevitably noisy. Background features might be distractive, while object points may also disappear. To deal with these problems and ensure robust match, a coherent point selection scheme for feature points includes the following. For each template point Fi, the best match target point fin(i) is found with a maximum g value, where m(.) denotes a mapping from template index to target index m(i). For the best match target point fm(i), its own best match template point Fm*(m(i)) is found, where m*(.) denotes another mapping from target index m(i) to template index m*(m(i)). A determination is made whether m*(m(i)) equals to 1. If it does, then point Fi and fm(i) are a pair of coherent points. This process is repeated, checking for all best target points. The coherent point selection criterion is satisfied only for close point pairs, making the matching process robust to noisy feature inputs.

Referring again to FIG. 1, in an operation 18, image transformation is performed in which the test image 12 is geometrically transformed, according to the positions of matched points. The image transformation can be the thin-plate splines interpolation described in F. L. Bookstein, “Principal warps: Thin-plate splines and the decomposition of deformations,” IEEE PAMI, 1989. The operations described with reference to FIG. 1 are repeated with different templates until there is convergence of the feature points for the template image 15 and the test image 12.

At the output stage, the match results can be represented as matched object part, matched feature points, and match confidence score. The match confidence score is defined as: S=Number_Coherent_Point/Total_Number_Feature_Point. The correct matching results in high scores. If S is greater than a preset threshold (>0.25), at least a quarter of feature points can find their best match points.

The methodology described was tested with 10 different objects. For each object, the experiments were repeated 10 times under different conditions (e.g., varying lighting, size, pose, rotation, translation). Each test lasted at least 1 minute. For each type of variation, the maximum range of tolerance was measured, in which reliable tracking was attained. Performance statistics are summarized in the Table below.

| | | | Upper | | | | | | | Book | |
|---|---|---|---|---|---|---|---|---|---|---|---|
| Object | Face | Eyes | Body | Toy owl | Cup | Phone 1 | Phone 2 | Radio | Book | stack | Mean |
| Detection rate | 10/10 | 10/10 | 10/10 | 10/10 | 9/10 | 10/10 | 9/10 | 9/10 | 10/10 | 9/10 | 9.6/10 |
| In-depth rotation | 60 | 45 | 60 | 30 | 30 | 30 | 30 | 60 | 45 | 30 | 42 |
| (degree) | | | | | | | | | | | |
| In plane rotation | 45 | 30 | 45 | 30 | 30 | 30 | 30 | 30 | 45 | 45 | 36 |
| Min Size (in | 50 | 60 | 50 | 50 | 50 | 40 | 50 | 40 | 50 | 50 | 49 |
| pixels) | | | | | | | | | | | |
| Max Size (in | 250 | 200 | 280 | 250 | 250 | 250 | 280 | 280 | 250 | 200 | 249 |
| pixels) | | | | | | | | | | | |

As shown in the Table, the minimum size is the lower bound of traceable object size. The maximum size is actually limited by the input video size (=320×240 in the prototype). The maximum size should expand, if the input video size is larger.

Advantageously, the exemplary embodiments provide a holistic feature matching method which can robustly match objects under different imaging conditions, such as illumination differences and intra-class variation-the apparent differences between instances of the same object class (e.g., faces of different people), scaling and varying view angles, occlusion and cluttered background. As such, end users can create a new recognition system through simple user-interactions. Results of exemplary embodiments are shown in the user interfaces of FIGS. 6 to 8.

FIG. 6 illustrates user interfaces of example face detection and tracking results under intra-class variation. A window 62 shows the input video frames. A window 64 shows the template and a window 66 shows the recognized objects. Templates can be loaded from saved image files.

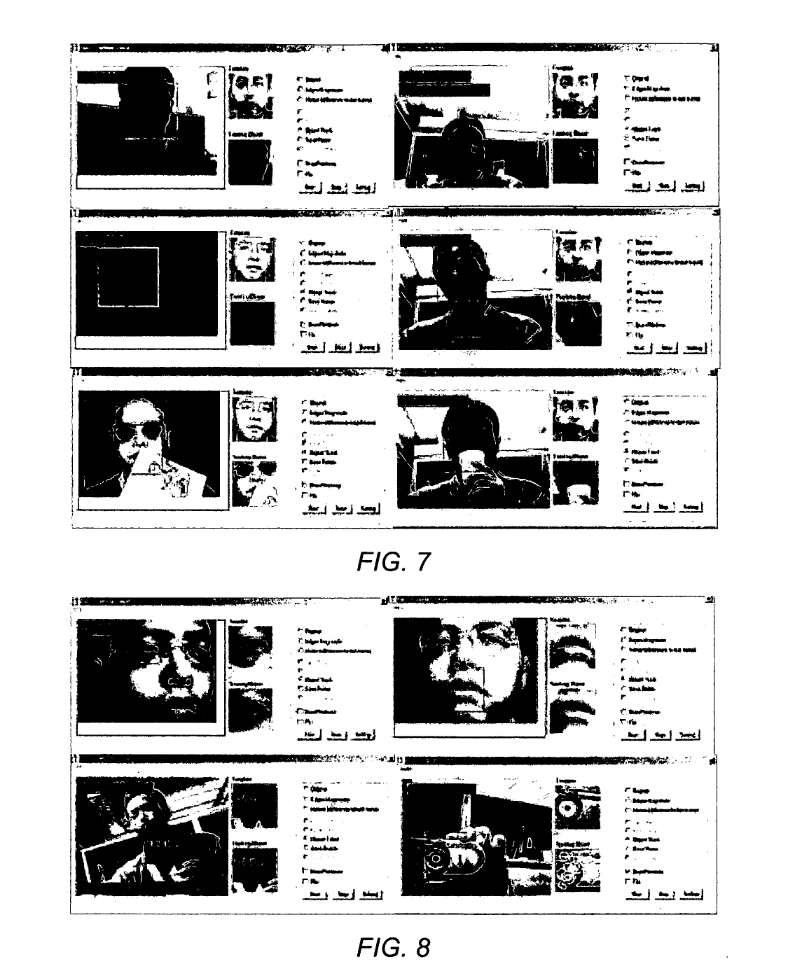

FIG. 7 illustrates user interfaces of example face detection and tracking results. Templates are specified by the user. Users can specify a single template by clicking mouse buttons to select interested regions from input video images and loading the template from a saved image file. The matching method described with reference to the FIGURES can successfully deal with illumination differences, scaling, partial occlusion and cluttered background. The method also tolerates in-depth object rotations to some extend (within 45 degrees). Further, the template image can be significantly different from test images in terms of object size, rotation, orientation, illumination, appearance and occlusion.

FIG. 8 illustrates user interfaces of example object detection and tracking results. By simply replacing the template image, the system tracks new object types without any modification or training. An end-user can easily create his or her own recognition systems by creating and using new templates. The recognition method can also track moving and rotating objects. As such, no training effort or expert knowledge is required. Advantageously, end users can create new recognition system, which can deal with significant image condition variations.

The following are example implementations of the exemplary embodiments described with reference to FIGS. 1-8. Other implementations could, of course, be used. One example implementation is content metadata extraction for images and video. In applications of intelligent image/video management, the exemplary embodiments can be used to extract information (e.g., presence, location, temporal duration, moving speed) about objects of interest. The extracted information (i.e., metadata) can be used to facilitate indexing, categorizing and searching images and video.

Another implementation is object (e.g., face, head, people) recognition and tracking for video conferencing. A video conferencing application can focus on interesting objects (e.g., people) and get rid of irrelevant background using the exemplary embodiments. Also, the conferencing application could transmit only the moving objects, thus reducing transmission bandwidth requirement. Another possibility is to augment video conferencing with 3D sound effects. The recognition/tracking method can recover the 3D position of speakers. This position information can be transmitted to the receiving party, which creates simulated 3D sound effects.

Yet another implementation is a low cost smart surveillance camera. When the exemplary embodiments are implemented on a board or integrated circuit chips, the cost and size of recognition systems can be significantly reduced. Surveillance cameras can be used in a wireless sensor network environment.

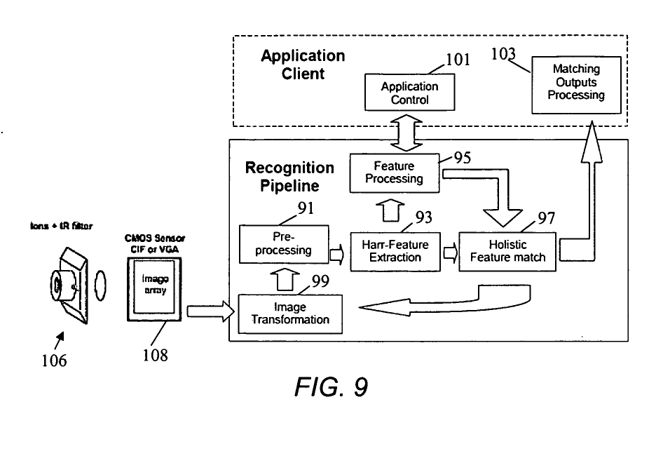

FIG. 9 illustrates an example image recognition hardware system. The example recognition system includes a pipeline design and interaction with an application client. The recognition system can take advantage of the image recognition model described with reference to FIGS. 1-8, allowing end-users to create their own recognition systems through simple user-interactions. The recognition system can take advantage of the iterative image matching method described with reference to FIGS. 1-8, which deals with illumination differences and intra-class variation, scaling and varying view angles, occlusion and cluttered background.

The recognition system uses a set of Harr-like description features, which are distinctive and invariant; a holistic match mechanism, which imposes constraints on both Harr-like quantities and spatial coordinates of feature points; a coherent point selection method, which robustly selects best match pairs from noisy feature points; and a match confidence score. The recognition system can include a pre-processing operation 91, which performs image intensity normalization, histogram equalization etc; a feature extraction operation 93 extracts Harr-like features; and a feature processing operation 95 which stores, selects and merges raw feature data, under the control of application client. The processed features are fed to a feature match operation 97 to match features and trigger an Image Transformation operation 99. The image transformation operation 99 performs sub-image (i.e. objects) cropping, scaling, rotation and non-linear deformation.

When a user selects an object of interest through some application user interface, corresponding features are extracted and stored. Alternatively, an object of interest can be loaded from saved images. Features are then matched with new input video frames. Matching outputs are interpreted and utilized by an application client using an application control operation 101 and a matching outputs processing operation 103. When objects of interest are viewed under different angles, common matched features are selected and stored. These features are then fed to the matching block to cater for objects under varying poses. Features extracted from different object instances of the same class can be further merged to cater for intra-class variations. This merged model allows recognition of general object classes, as opposed to single object instance.

The recognition system described with reference to FIG. 9 utilizes a general purpose recognition hardware design, such that it can work for arbitrary objects without any modification of the design or re-training of the system. The application client may be either a software application running on a computer device, or a simple hardware controller. In the first form, the computational cost of client PCs is reduced. In the latter form, the hardware cost on vision systems is significantly reduced. The general-purpose image recognition system provides for possibilities in many real-time mobile applications like vision-based user interaction, instantaneous video annotation etc. It can also be used for vision-based robot navigation and interaction.

As depicted in FIG. 9, a camera 106 is connected to one or multiple processors 108, where the matching algorithm of the exemplary embodiments is embedded into the pipeline.architecture. Such a device can perform the same vision ability as the software simulation, but at several times higher speed.

The sensor signal can be fed into the recognition system or recognition pipeline via a camera port interface. The recognition results (e.g., localization, shape, orientation and confidence score of recognized objects) are output in compact formats. The control interface from the application control operation 101 defines the work mode and exchanges feature data, extracted from and/or fed into the system.

The recognition system described with reference to the FIGURES is versatile and provides real-time vision recognition. The system can be implemented in mobile devices, robots, or other computing devices. Further, the recognition system or pipeline can be embedded into an integrated circuit for implementation in a variety of applications.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

While several embodiments of the invention have been described, it is to be understood that modifications and changes will occur to those skilled in the art to which the invention pertains. Accordingly, the claims appended to this specification are intended to define the invention more precisely.

1. A method of image matching a test image to a template image, the method comprising:
extracting features from a test image, wherein the extracted features are Harr-like features extracted from key points in the test image;
matching extracted features from the test image with features from a template image;
transforming the test image according to matched extracted features; and
providing match results.

2. The method of claim 1, wherein matching extracted features from the test image with features from a template image comprises performing a holistic feature matching operation such that features are similar in terms of Harr quantities and have consistent spatial configurations.

3. The method of claim 2, wherein the matching extracted features from the test image with features from a template image utilizes a formula to define good match points (g), where the formula is
$$g = exp ( - \frac{d}{σ} - \frac{f}{γ} )$$
where f is mean squared Harr and d is mean squared spatial differences.

4. The method of claim 1, wherein the template image and the test image have illumination differences.

5. The method of claim 1, wherein the template image and the test image have intra-class variation.

6. The method of claim 1, wherein the template image and the test image have scaling and varying view angles.

7. The method of claim 1, wherein the template image and the test image have occlusion and clutter backgrounds.

8. The method of claim 1, wherein the Harr-like features comprise a set of distinctive and invariant Harr-like description features.

9. The method of claim 1, wherein matching extracted features from the test image with features from a template image comprises selecting coherent points which are best match pairs from noisy feature points.

10. A device having programmed instructions for image recognition between a test image and stored template images, the device comprising:
an interface configured to receive a test image;
an extractor configured to extract features from the test image, wherein the extracted features are Harr-like features extracted from key points in the test image; and
instructions that perform a matching operation where extracted features from the test image are matched with features from a template image to generate match results.

11. The device of claim 10, wherein the matching operation compares Harr quantities and spatial configurations of the features.

12. The device of claim 10, wherein the matching operation utilizes a formula to define good match points (g), where the formula is
$$g = exp ( - \frac{d}{σ} - \frac{f}{γ} )$$
where f is mean squared Harr and d is mean squared spatial differences.

13. The device of claim 10, wherein the template image and the test image have illumination differences.

14. The device of claim 10, wherein the template image and the test image have intra-class variation.

15. The device of claim 10, wherein the matching operation selects coherent points which are best match pairs.

16. The device of claim 15, wherein the best match pairs are from noisy feature points.

17. The device of claim 10, wherein the device is selected from the group consisting of a mobile device, a robot and a computing device.

18. A system for image recognition, the system comprising:
a pre-processing component that performs image normalization on a test image;
a feature extraction component that extracts Harr-like features from the test image, wherein the Harr-like features are from key points in the test image;
a matching component that matches features extracted from the test image with features from a template image; and
an image transformation component that performs transformation operations on the test image.

19. The system of claim 18, wherein the matching component tests features based on Harr quantities and spatial configurations.

20. The system of claim 18, wherein the matching component selects coherent points from the test image and the template image which are best match pairs.

21. The system of claim 20, wherein the best match pairs are from noisy feature points.

22. The system of claim 18, wherein the transformation operations performed by the image transformation component comprises any one of cropping, scaling, rotation, and non-linear deformation.

23. The system of claim 18, further comprising a feature processing component that selects and merges feature data from the test image.

24. A software program, embodied in a computer-readable medium, for image matching a test image to a template image, comprising:
code for extracting features from a test image, wherein the extracted features are Harr-like features extracted from key points in the test image;
code for matching extracted features from the test image with features from a template image;
code for transforming the test image according to matched extracted features; and
code for providing match results.

25. The software program of claim 24, wherein the code for matching extracted features from the test image with features from a template image comprises code for performing a holistic feature matching operation such that features are similar in terms of Harr quantities and have consistent spatial configurations.

26. A system for image matching a test image to a template image, the method comprising:
means for performing image normalization on a test image;
means for extracting Harr-like features from the test image, wherein the Harr-like features are from key points in the test image;
means for matching features extracted from the test image with features from a template image; and
means for performing transformation operations on the test image.

27. The system of claim 26, wherein the matching means tests features based on Harr quantities and spatial configurations.
